(19) United States
(12) Patent Application Publication
(10) Pub. No.: US 2012/0109945 A1
(43) Pub. Date: May 3, 2012

(54) METHOD AND SYSTEM OF IMPROVING NAVIGATION WITHIN A SET OF ELECTRONIC DOCUMENTS

(76) Inventor: Emilia Maria Lapko, Trzebiez (PL)

(21) Appl. No.: 13/025,920

(22) Filed: Feb. 11, 2011

Related U.S. Application Data
(60) Provisional application No. 61/408,395, filed on Oct. 29, 2010.

(51) Int. Cl. G06F 17/30

(52) U.S. Cl. 707/723; 707/E17.014

(57) ABSTRACT

A method and system of improving navigation within a set of electronic documents includes an optional first step (234) of collecting information describing a user's task context, and identifying a set of keywords representing a user's recent document viewing and current task context. A next step (240) includes querying one of the available sources of documents, and identifying a candidate document. A next step (250) includes calculating a document characterization metric. A next step (260) includes calculating a document score that characterizes a user's anticipated level of comfort with a document. A next step (270) includes selecting and displaying a document with the best score.

### RELATED APPLICATION

This application for letters patent relates to and claims the benefit of U.S. Provisional Patent Application No. 61/408,395, titled “METHOD AND SYSTEM OF IMPROVING NAVIGATION WITHIN A SET OF ELECTRONIC DOCUMENTS”, and filed on Oct. 29, 2010; the disclosure of which this application hereby incorporates by reference.

### BACKGROUND OF THE INVENTION

1. Field of the Invention

This invention relates generally to the field of information retrieval, and more particularly to providing a user interface (UI) that facilitates navigation within a set of electronic documents.

2. Background Art

The amount of information available on the Internet is enormous. Thus, effective navigation techniques are essential. An article from July 2010 (http://www.scrippsnews.com/content/how-big-internet-no-one-really-knows) stated that Microsoft's Bing search engine team estimated the number of Web pages at over one trillion, and that Google said it has already indexed more than one trillion discrete Web addresses.

Search engines have evolved to become the preferred method of navigating the public Internet as well as private Intranets. Other traditional navigation aids include site maps, searchable help files, and compilations of peer- or expert-selected hyperlinks. Navigation within a collection of documents should be facilitated according to the user's context and knowledge need. There is a considerable difference between looking for a specific fact or answer, which might be found if the user knows the keywords with which the content was indexed, and browsing for general topic information, or even entertainment.

A user surfing the Net often jumps between different services and pages, accessing specific pages without knowing their relation to the architecture of the Web site in which they are stored. Thus, there is the potential to get lost. Web browsers can store a history of viewed pages, but the listing of addresses and page names may not be sufficient guidance for a Net surfer to get back on track. Browsers also contain a “Back” button; however, as described in Greenberg, S. and Cockburn, A, “Getting Back to Back: Alternate Behaviors for a Web Browser's Back Button”, Proceedings of the 5th Annual Human Factors and the Web Conference, Held at NIST, Gaithersburg, Md., USA, Jun. 3, 1999, there are limitations, and opportunities to improve on the functionality of the basic “Back” button.

Predictive hyperlinks have been proposed as an improvement in navigation, anticipating where the user wants to go next. Such methods utilize a history of pages that the user has viewed, to predict where the user would like to go, and may provide a button that takes the user there. However, they do not attempt to understand the reasons why the user wants to go back to a certain page, e.g., to return to a page with less advertising, less advanced terminology, more concise content, etc.

Individual and social tagging of pages, e.g., as favorites, is another way to identify content of interest, to simplify navigation and to provide a means for a user to return to a page of interest. Visual Search techniques, such as those implemented at http://www.bing.com/visualsearch, provide users more context information to browse content collections. Nevertheless, current navigation methods do not adequately account for changes over time in users' search styles (linear, random walk, spiral, etc.) and knowledge needs (broad, narrow, old, new, validated, innovative, etc.) Neither do they provide a personalized, intelligent function to take a user back to a Web site/page where he/she feels comfortable with the content and does not consider himself/herself to be “lost”. From the perspective of the Web site owner, there is also the need to help visitors avoid getting lost, and keep them interested and engaged with the Web site, leading to improved sales, increased customer loyalty, higher page ranking, etc. Accordingly, there is thus a need for an improved technique for navigation within a set of electronic documents.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an architecture diagram of one embodiment of the invention, wherein five different sources of electronic documents are utilized;

FIG. 2 is a flowchart presenting a method of selecting an electronic document to be displayed to a user;

FIG. 3 depicts an example document source preference settings menu, which is useful for understanding the present invention;

FIG. 4 depicts an example document navigation element, which is useful for understanding the present invention;

FIG. 5 depicts additional examples of document navigation elements, which are useful for understanding the present invention;

FIG. 6 is a flowchart presenting a method of identifying documents, from among a set of content items labeled as favorites on a Social Networking site; and

FIG. 7 depicts an example of document characterization data, which are useful for understanding the present invention.

### DETAILED DESCRIPTION OF THE INVENTION

The present invention provides an improved technique for navigation within a set of electronic documents. The improvement in navigation is achieved by means of an intelligent document navigation element which, in the preferred embodiment, may be located within an HTML document. In a second embodiment, the document navigation element may be located within a second HTML document which may be displayed to the user while viewing a first HTML document. The transparency of the displayed second HTML document may be adjusted so as to allow the user to view both the first and the second HTML document, the latter containing the document navigation element. One or more document navigation elements may appear on one or more Web pages within a Web site or Web portal. In other embodiments, the document navigation element may be implemented as a plug-in or add-in to a Web browser, such as Internet Explorer, Firefox, Mozilla, etc., or within an interactive content item, e.g., an animation sequence developed using Action Script by Adobe.

The document navigation element (DNE) includes a User Interface (UI) element, a DNE service, and a DNE data store. The DNE may also include an interface to another service available within its computing environment. In one embodiment, the DNE service may be implemented as a Java program, which may be run on Web browsers and computers with the Java Virtual Machine (JVM).

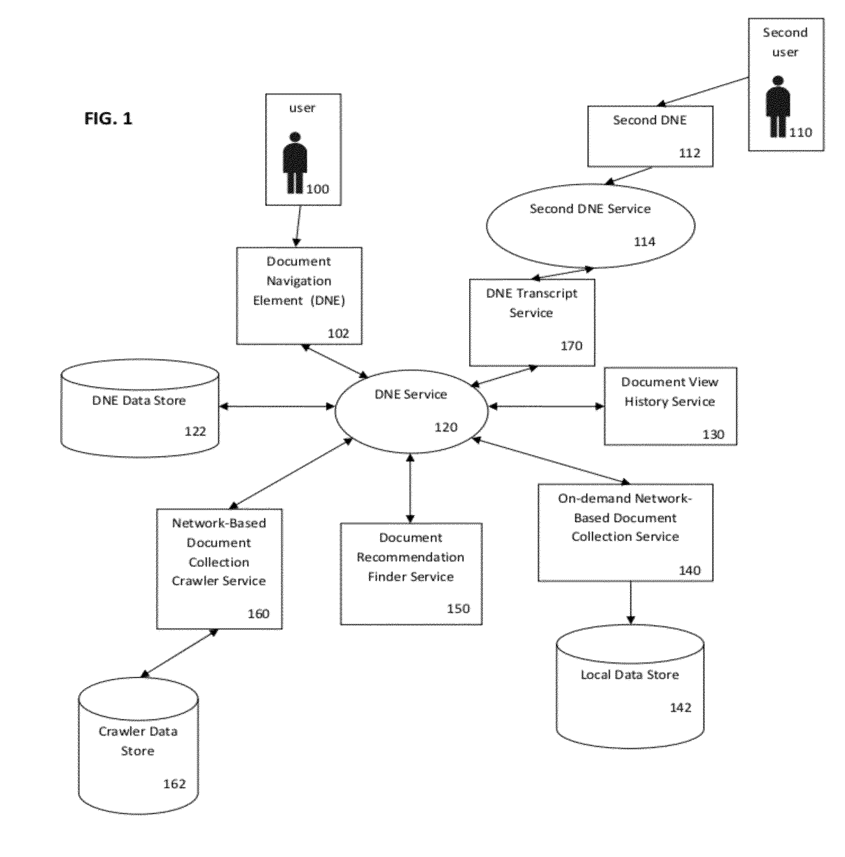

Referring to FIG. 1, a human user (100) may interact with a document navigation element (DNE) (102), which is communicatively linked with a DNE service (120). The DNE service (120) receives from the DNE the values input by the user to the DNE, as well as corresponding identifiers for the interactive sections of the DNE selected by the user, e.g., clicking a radio button, pulling a slider menu to the desired location, and checking a checkbox. The DNE (102) receives from the DNE service (120) instructions for modifying aspects of the DNE (102), including but not limited to, its color, layout, size, active (or inactive) buttons, active (or inactive) text input fields, text displayed to the user, visual media displayed to the user, and audio media played for the user.

The DNE data store (122) is communicatively linked with a DNE service (120) periodically exchanging information, such as a default setting for the DNE's document source preference settings menu, document characterization metrics, and other information types which will be explained herein. The DNE service (120) may also be communicatively linked with one or more of the following services: a document view history service (130), an on-demand network-based document collection service (140), a document recommendation finder service (150), a network-based document collection crawler service (160), and a DNE element transcript service (170).

The DNE service (120) may issue a request to a document history service (130), such as an Internet browser, and subsequently receive a list of the addresses of Web pages viewed by the user. The DNE service (120) may subsequently copy to the DNE data store (122) documents from an Internet browser's local cache or retrieve copies of pages based on addresses provided by the document view history service (130), to facilitate further processing. The DNE service (120) may issue a request, including a search string or other such description of the user's knowledge need, to an on-demand network-based document collection service (140) to collect a set of related documents. The Vizit™ tool developed by the University of Illinois at Urbana-Champaign and National Center for Supercomputing Applications (NCSA), functions as a .NET plug-in to the Internet Explorer Web Browser, and is one example of a program that collects a specified number of documents and constructs an index of such documents, in response to a query to the Google Application Programming Interface (API), subsequently storing copies of such documents in an Extensible Markup Language (XML) representation in a local data store (142). The DNE service (120) may subsequently copy the XML documents from the local data store (142) to the DNE data store (122) to facilitate further processing.

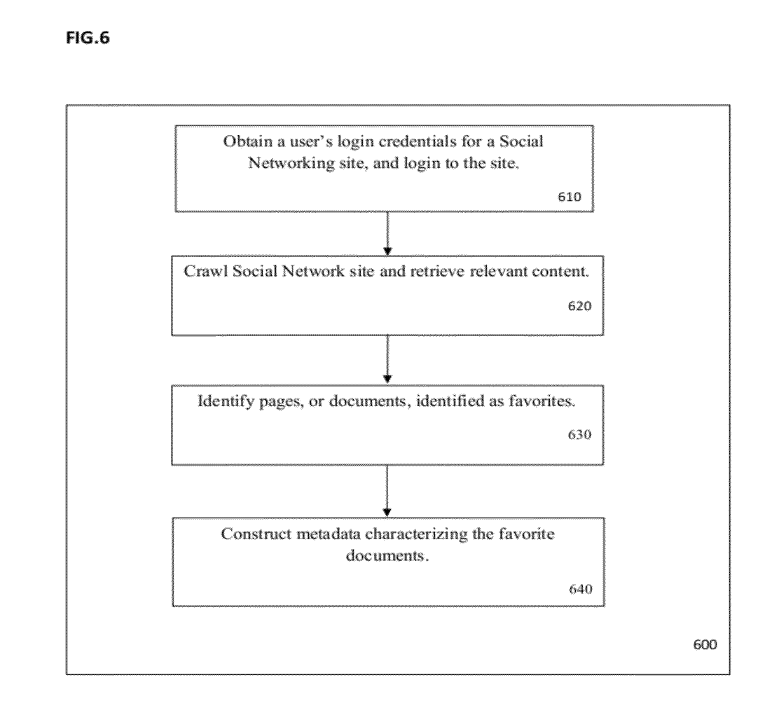

The DNE service (120) may issue a request to a document recommendation finder service (150) as may be implemented in conjunction with a Social Networking site, e.g., Facebook™, LinkedIn™, and YouTube™. As used herein, a social network is a social structure having a group of people that are linked together by one or more common links. These links may include friendship interdependency, familial ties, employment status, common likes, common dislikes, common subject matter interests, and so forth. As used herein, a Social Networking site is a collection of networked information services for members of a social network. The DNE service (120) communicates the user's Social Network site identity and access credentials to the document recommendation finder service (150), which subsequently communicates with a Social Network site and constructs a collection of content items including that which members of the user's social network have labeled as “favorites”, “likes”, “recommendations”, “top picks”, “most popular”, or the like. Herein the term “favorite” is used generically to designate a content item identified as suitable for a given user. Operation of the document recommendation finder service (150) will be further explained by means of the flowchart in FIG. 6.

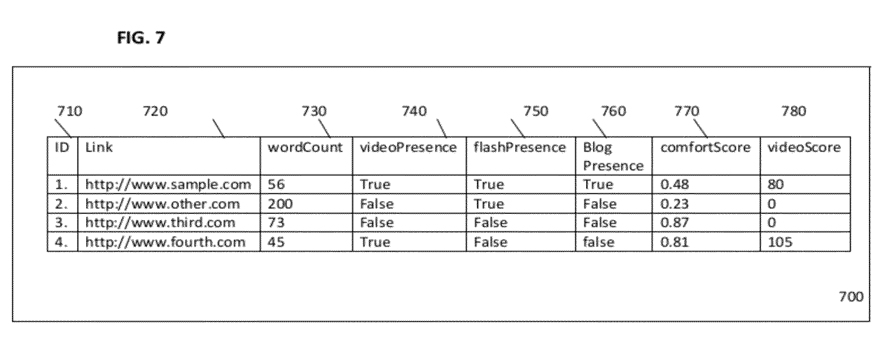

The DNE service (120) may issue a request, including a search string or other such description of the user's knowledge need, to a network-based document collection crawler service (160), which stores its results in a crawler data store (162). As will be understood by someone skilled in the art, a crawler periodically analyzes content to which it has access, and constructs an index of this content, typically identifying keywords which may be used for searching this content. The network-based document collection crawler service (160), in addition to performing the typical functionality of a Web crawler, may calculate document characterization metrics, as will be further explained by means of the example in FIG. 7. When the DNE service (120) queries the network-based document collection crawler service (160), may return not only an index of topically related pages but also their respective values of document characterization metrics, both of which may be stored in the DNE data store (122).

The DNE service (120) may receive a request from a DNE transcript service (170) to add to its DNE data store (122) the information contained in a DNE transcript generated by a second DNE service (114). A second user (110) interacts with the second DNE service (114) by means of a second DNE (112). A DNE transcript may contain a list of pages viewed by a second user (110), a configuration setting for the second DNE (112), and other information that the second user (110) wishes to share with the user (100). In one embodiment, a DNE transcript may be represented in XML format and communicated via e-mail. Accordingly, the user (100) may select an option on the DNE (102) which instructs the DNE service (120) to read the DNE transcript, and either append to or overwrite the existing information in its DNE data store (122).

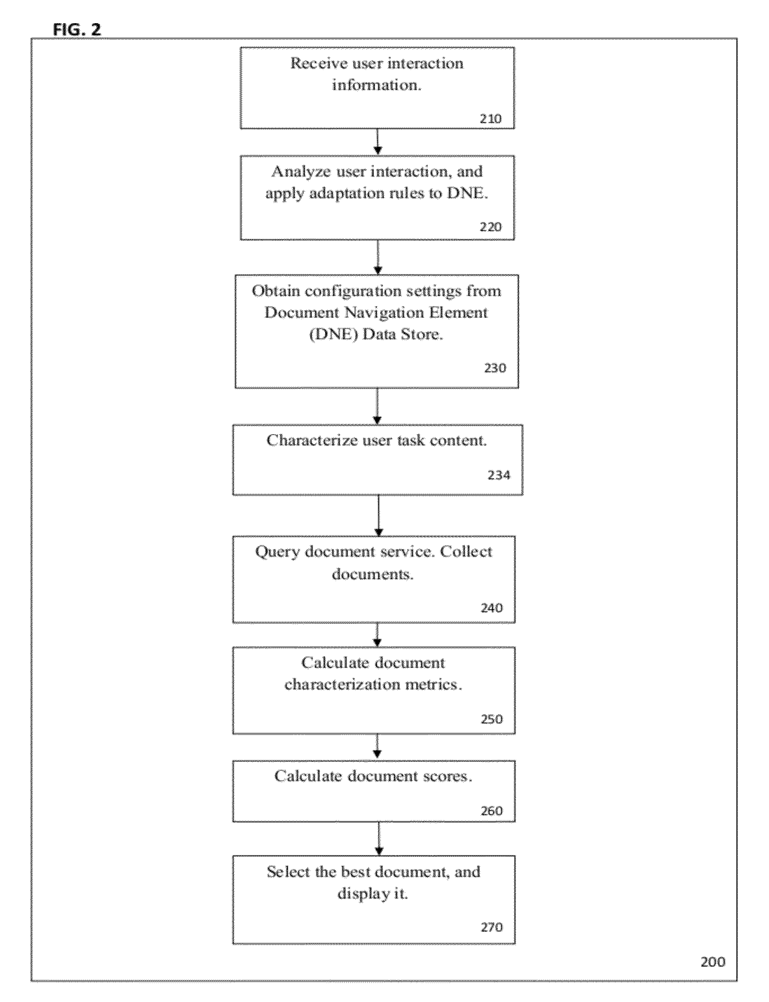

Referring now to FIG. 2, the operation of the DNE service (120) will be explained in sufficient detail for one skilled in the field to implement it. The DNE service process (200) begins with step 210 in which the DNE service receives information about a user's interaction with the DNE (102). At step 220, the DNE service (120) applies a set of rules or other instructions from its DNE data store (122), identifies applicable rules, and communicates with the DNE (102) the corresponding changes prescribed by these rules, e.g., changing the DNE color, layout, size, active (or inactive) buttons, active (or inactive) text input fields, text displayed to the user, visual media displayed to the user, audio media played for the user, and haptic feedback provided to the user. At step 230, the DNE service (120) queries its DNE data store (122) to obtain configuration settings as may be used to control the subsequent steps of the DNE service process (200), e.g., document source preference settings, document scoring rules.

At step 234, the DNE service (120) accesses one or more source of user context information, e.g., Browser history, cookies, or past selections by the user via the DNE (102), to characterize the user's current task context, e.g., “looking for information about new cars”, “browsing for general information about tropical plants”, “looking for something funny”, and “looking to buy a new pair of leather shoes”. At step 240, the DNE service (120) may in one embodiment, use the context information gathered at step 234 to generate keywords which may be communicated with an on-demand network-based document collection service (140) or network-based document collection crawler (160). For example, “(review OR recommend) new car”, “(information OR overview) tropical plant”, “entertainment (funny OR humor OR joke)”, and “(purchase OR buy OR sell) leather shoe”, may correspond to the previously mentioned task context descriptors. Subsequently, at step 240, the DNE service (120) issues a document query to one or more of the following: a document view history service (130), an on-demand network-based document collection service (140), a document recommendation finder service (150), a network-based document collection crawler service (160), and a DNE element transcript service (170). The results of the document query are written to the DNE data store (122).

At step 250, the DNE service (120) applies its document characterization metric calculation rules, and updates the respective entries in its DNE data store (122). In an alternative embodiment, the DNE service (120) may reuse a document characterization metric provided by the document view history service (130), on-demand network-based document collection service (140), document recommendation finder service (150), network-based document collection crawler service (160), or DNE element transcript service (170).

The following are examples of some of the possible methods for calculating document characterization metrics which may be implemented at step 250. A metric name, metric type (integer variable, logical true-false variable, floating-point number variable, etc.), metric range, and calculation method are provided.
wordCount: integer [0, +infinity): Count the words appearing in the user-viewable portion of an HTML page, i.e., the words appearing as text when the page is displayed in an Internet browser.
videoPresence: logical: Scan an HTML page to identify tags of the form <a href=“path/name.extension”>. If any of these tags contain an extension, indicating that the content is a video (AVI, MPEG, etc.), then videoPresence=true.
videoContentFactor: float [0,1]: Scan an HTML page to identify the percent of the page area occupied by video content. This may be done by comparing the browser's environment variables (height, width) to HTML tags specifying the dimensions of the displayed video content. In one embodiment, the factor may account for the size (in kilobytes) of the video content relative to the total content of the page.
videoDurationSeconds: float [0, +infinity): Scan an HTML page to identify tags of the form <a href=“http://path/name.extension”>. If any of these tags contain an extension, indicating that the content is a video (AVI, MPEG, etc.), then read the metadata associated with the file name.extension to ascertain its Duration (HH:MM:SS). If multiple video content items are located on a page, then calculate the total of their Durations.
flashPresence: logical: Scan an HTML page to identify tags of the form <script type=“text/javascript”>. If the interface code to the corresponding Javascript program contains a call to the function “SWFObject”, then flashPresence=true.
blogPresence: logical: Scan an HTML page to identify tags of the form <a href=“http://path/name.extension”>. If any of the HREF tags correspond to known blog sites, e.g., http://lajt.onet.pl/blog/, then blogPresence=true.
informationDepth: float [0,100]: Scan an HTML page, and construct a list of the text and textual metadata from the page. Within a working copy of WordNet (http://wordnet.princeton.edu), plot the location of each word occurring in this list. When a word occurs multiple times, assign a weight to the corresponding node equal to the number of times that the word has occurred. Subsequently, compute a structural metric characterizing the compactness and interconnectedness of the network of word-nodes, i.e., a subset of WordNet which contains words that appear in a document. In one embodiment, the least interconnected, broadest spanning (in terms of the average distance between nodes) network will result in a metric value of 0, and the most interconnected, narrowest spanning network will result in a metric value of 100. One may, for example, apply Social Network Analysis (SNA) metrics such as density, which is a measurement of a node's communication links as a proportion of the nodes of the network. Density measures the proportion of communication channels existing in a social network relative to all possible communication channels.

Additional metrics may include characterizing the presence of banner ads, the presence of specific multimedia types (JPEG, AVI, WAV, etc.), the presence of specific document types (DOC, PDF, etc.), the presence of a link to download software/shareware/freeware, the price of an item advertised for sale, the presence of a discounted item (advertised as “on sale”, “specially priced”, having a “limited time offer”, being a “special promotion”, or variants thereof), the number of items with discounted prices (for example, as denoted by the presence of a currency number displayed in a strike-through type font and a second currency number displayed in close vicinity), the time since the page was last updated (for example, as might be indicated by a metadata tag within the HTML source code), the presence of an indicator on the page showing where in the hierarchy of a web site the page is located, the status of a page (main page, entry page, site map, etc.) within the hierarchy of a web site, and the information content (relative to the number of ads or size of the document).

The following are examples of some possible methods for calculating user-centric document characterization metrics that address the user's perceived experience, the document's ability to satisfy a user's knowledge need, or a user's previous interaction with the document:
semanticDistance: float [0, +infinity): For each of the keywords generated at step 240, based on the context information gathered at step 234, count the number of intermediate links between this keyword and each word in the document, using WordNet. The semantic distance may be computed as the average number of intermediate links in WordNet between each keyword and each word in the document. In one embodiment, specific parts of speech (nouns, verbs, adjectives, adverbs, prepositions, pronouns, etc.) may be omitted from this calculation to improve its computational efficiency.
pageVisits: integer [0, +infinity): Count the number of times that the user has visited the given page.
personalFavorite: logical: If the user has bookmarked the page within an Internet browser, or included the page within a favorites list, then personalFavorite=true.

Additional metrics may include degree of fit with the user's cognitive model, degree of fit with the user's current emotional state (happy, sad, angry, anxious, etc.), the sentiment (positive, neutral, or negative) of the page, degree of fit of the text with the typical vocabulary of the user's actual or desired reading level, and degree of fit of terminology (including jargon and field-specific terminology) with the user's level of expertise in the primary/secondary/other field to which the page pertains.

At step 260, the DNE service (120) calculates a score for each document in the set of documents collected in step 240, by means of applying a document scoring rule, which corresponds to a user's interaction with the DNE (102) at step 210. In one embodiment, a DNE data store (122) may contain one document scoring rule, producing a score on the [0,1] range, for an action that a user may perform with the DNE (102). The following are some examples of possible document scoring rules:
complexityScore: One may compute a complexity score as follows, starting with a default complexity score of 1.0 points. If the page contains banner ads, then subtract 0.25 points. If the user has visited the page before, then subtract 0.05 points for each visit, up to a maximum of 0.25 points deducted. Subtract 0.15 points if the page contains fewer than 50 user-viewable words. Subtract 0.10 points if the page contains fewer than 100 user-viewable words. Subtract 0.02 points for each grade level (Kindergarten through Grade 12) whose typical vocabulary includes all of the words used in the page, up to a maximum of 0.25 points deducted.
comfortScore: One may compute a comfort score as follows, starting with a default comfort score of 0.0 points. Multiply the complexityScore by 0.75, and add that many points to the comfortScore. Add 0.1 point if all text is displayed larger than 10 point size. Add 0.1 point if the number of lines of text, as displayed within the user's preferred Internet browser, using that browser's default settings, is less than 15. Add 0.05 points if the text area of the document as displayed covers at least 90% of the area of the user's display.
informationDepthMatchScore: One may compute an information content match score=−ABS((desired informationDepth)−(actual informationDepth))/(desired informationDepth), where ABS denotes the absolute value.
videoScore: One may compute a score as follows. If videoPresence=true, then videoScore=videoContentFactor*videoDurationSeconds, else videoScore=0.0.

At step 270, the DNE service (120) selects the document with the highest score, based on a scoring rule, and displays that document to the user. In one embodiment, the selected document may replace the document currently being displayed to the user. In another embodiment, the selected document may be displayed in a new window. In yet another embodiment, multiple high-scoring documents may be displayed to the user.

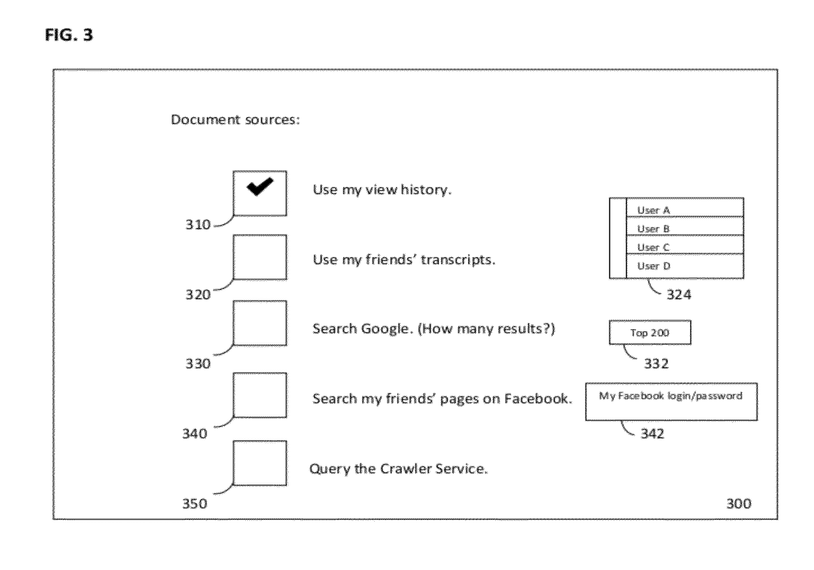

Referring now to FIG. 3, the document source preference settings menu (300), which the user (100) accesses via the DNE (102) provides a method of communicating to the DNE service (120) the desired document sources. Checkbox 310 indicates that the user's document view history is to be included by means of the document view history service (130) at step 240. Checkbox 320 indicates that a DNE transcript which the user has obtained from a second user and subsequently accessed via the DNE transcript service (170), is to be included, and that the users' transcripts selected in the DNE transcript inventory (324) are to be included at step 240. Checkbox 330 indicates that the desired number of new search results (332) are to be included by means of the on-demand network-based document collection service (140) at step 240. Checkbox 340 indicates that using the supplied logon credentials (342), documents referenced by the user's Facebook™ pages or friends' Facebook™ pages are to be included by means of the document recommendation finder service (150) at step 240. The example in FIG. 3 is provided for illustrative purposes only, and does not indicate a limitation to a specific Social Networking site. Checkbox 350 indicates that documents obtained by means of the network-based document collection crawler service (160) are to be included at step 240.

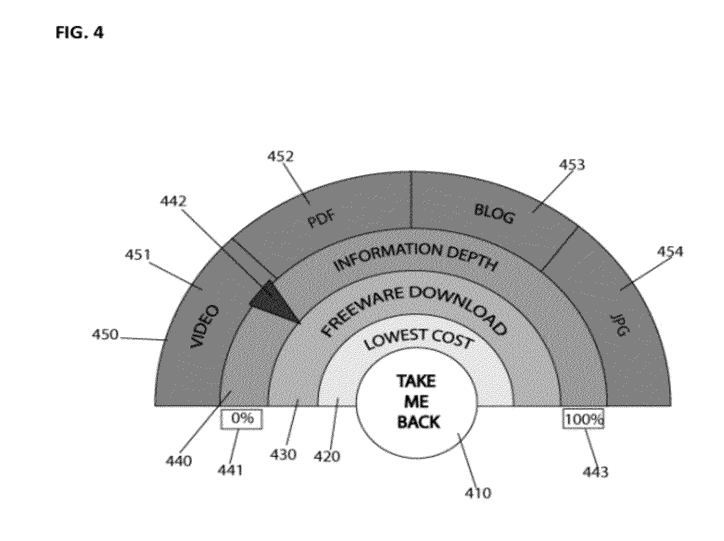

Referring now to FIG. 4, the structure and operation of an example DNE (102) are explained. When the user clicks on the central button (410) labeled “Take Me Back”, the DNE service (120) identifies and displays the document from among the selected document sources which has the largest comfortScore, as calculated at step 250. It is envisioned that in specific embodiments, various tie-breaking methods, e.g., the first document to appear in the list of candidate documents, may be employed to select one document from among several documents having the same comfort score. Clicking the “Lowest Cost” button (420) launches the DNE service (120) and instructs it to use a document scoring rule that prioritizes documents based on document characterization metrics computed at step 240 that identify a document as being related to the user's current context, having a product or service for sale, and having the lowest cost offer for said product or service. Clicking the “Freeware Download” button (430) launches the DNE service (120) and instructs it to use a document scoring rule that prioritizes documents based on document characterization metrics computed at step 240 that identify a document as containing a link with which the user may download freeware related to the user's current context. Clicking on the slider control (442), moving it to the desired location on the “Info. Content” region (440), somewhere between the minimum value (441) and the maximum value (443), launches the DNE service (120) and instructs it to use a document scoring rule, e.g., informationDepthMatchScore, that prioritizes documents based on document characterization metrics computed at step 240, that identify a document as containing a desired information depth level as specified by the user via the slider control (442).

The media format option zone (450) enables the user to specify a preferred media format. Clicking the “Video” button (451) launches the DNE service (120) and instructs it to use a document scoring rule, e.g., videoScore, that prioritizes documents based on a their video content. Clicking the “PDF” button (452) launches the DNE service (120) and instructs it to use a document scoring rule that prioritizes documents in Adobe PDF format and documents with links to other documents in Adobe PDF format. Clicking the “Blog” button (453) launches the DNE service (120) and instructs it to use a document scoring rule based on document characterization metrics, e.g., blogPresence, that prioritize documents that are a blog or contain links to a blog. Clicking the “JPEG” button (454) launches the DNE service (120) and instructs it to use a document scoring rule that prioritizes documents in image files in JPEG format and documents with links to images in JPEG format.

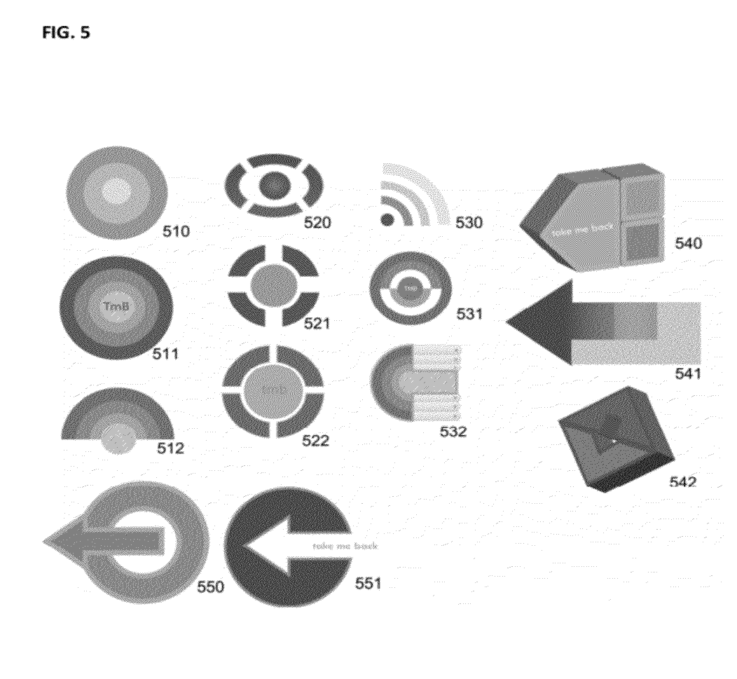

Referring now to FIG. 5, the structure and operation of additional examples of some possible DNEs are briefly explained. Elements 550 and 551 are single-function elements, with which the user may click on the centrally located arrow labeled with the text “Take Me Back”, and the DNE service (120) will subsequently take the user to a document with the highest comfortScore, from among the set of documents considered by the DNE service. In 551, when the user clicks on the central arrow, it changes color to a complementary (to the outer circle) color. In another embodiment, the central arrow in 551 moves in the direction of the arrow, when the user clicks on it, thereby providing a visual cue that the user's request has been submitted to the DNE service.

Element 542 is configured for inclusion in a three-dimensional document, providing two active areas, clicking on which the user may initiate one of two possible functions. Additionally, the user may click and drag one of the parts relative to the other part, thereby supplying a sliding scale input. Elements 510, 511, and 512, are a group of elements that illustrate a varying number of active control areas that may be included in a DNE. By quickly double-clicking on the element, the user may cause the element to change the number of circular areas that are displayed, i.e., increasing or decreasing the number of actions that are available to the user. The semicircular element 512 may be attached to a window, region, table, etc., within a document. The attachment may occur when the document is initially displayed to the user, or at some later time. In one embodiment, when the user moves the DNE and attaches it to a different section of the document, e.g., a window for viewing a video, the DNE service (120) automatically obtains metadata from this section of the document (where the DNE is now located), and modifies the user task context accordingly, e.g., for use with the on-demand network-based document collection service (140).

Elements 520, 521, and 522 illustrate a DNE with five active areas, e.g., with the central area functioning as a “Take Me Back” button, selecting for the user a document with the highest comfortScore from among the available documents. By manipulating the four surrounding areas arranged in a circular (or oval) pattern around the central button, e.g., by clicking and dragging them closer or further away (along a radial axis from the center of the element), the user may specify an increase or decrease in the importance of a characteristic, e.g., “PDF”, “video”, “free offer”, “buy now”, etc. The DME service (120) at step 260 may include in the document rating score a component corresponding to the selected area, weighted by its distance from the center of the DNE.

Element 530 illustrates a DNE that may be attached to a rectangular corner of a display screen. This type of DNE may be expanded (or minimized) by executing an appropriately timed click sequence, e.g., two clicks within 1 second. Element 531 illustrates a DNE with multiple concentric slider controls. In this illustration, the two controls located closest to the center of the “Take Me Back” button are set at 50%, and the outermost control is set at 100%. Element 532 illustrates a DNE that provides the user the option to easily guide the document search to one of the available sources. In one embodiment, the buttons arranged to the left of the central “Take Me Back” button indicate that documents are to be selected from documents that the user or the user's friends have previously viewed. In a complementary manner, the buttons arranged to the top-right and bottom-right of the central button indicate that documents are to be selected from other, infrequently viewed sources, e.g., a network-based document collection crawler service (160). Within each subset, e.g., left, top-right, and bottom-right, the buttons provide the user different document selection options, e.g., more text, must have at least one JPEG image, etc.

Element 540 illustrates a three-dimensional DNE which the user may construct and modify. For example, clicking and dragging the block for “JPEG” in front of the block for “Video” will create a three-dimensional button that when clicked will initiate a search for both “JPEG” and “Video”. Element 541 illustrates a DNE with a “Take Me Back” button (on the left side of the arrow, in this example), and two other control areas. Whereas the bottom of these two control areas has a single action button, the top control area has three action buttons corresponding to three representative ranges for the control, e.g., documents with fewer than 30 words, between 30 and 100 words, or more than 100 words.

Referring now to FIG. 6, the operation of the document recommendation finder service (150) will be explained with the assistance of a flowchart (600) of process steps it performs. At step 610, the service (150) acquires, e.g., from the DNE service (120), the user's login credentials for a Social Networking site, and performs the required user login procedure for the site. At step 620, the service (150) accesses the user's pages on the Social Networking site, and retrieves a local copy of these pages. The service (150) also stores the addresses of these documents in working memory. In one embodiment, the service (150) may search within the user's Social Networking site pages for content tags identifying links to the Social Networking site pages of the user's friends, and retrieve a local copy of these pages. The addresses of these pages are likewise added to the working memory. In another embodiment, the service (150) may search within the Social Networking site pages of a user's friends for content tags identifying links to the Social Networking site pages of their friends, and subsequently retrieve a local copy of such pages. The addresses of these pages are likewise added to the working memory.

At step 630, the service (150) analyzes the local copies of pages searching for content tags that identify documents recommended by the user, the user's friends, or the user's friends' friends. As used herein, “document” includes any content item that may be found on a Social Networking site. It should be noted that the three-level (user/friend/friend-of-friend) example in FIG. 6 does not limit the number or distance of relationships that may be considered by the service (150).

At step 640, the service (150) constructs metadata characterizing the favorite documents, for example, a table containing the addresses of the recommended documents, and summary data which may include the number and names of people recommending them. In one embodiment, the service (150) may calculate document characterization metrics, e.g., blogPresence, while it scans the pages searching for content tags indicating a page's status as a favorite, or at another time analyzing a locally stored copy of the pages. The table is subsequently communicated to the DNE service (120) which requested its generation.

Referring now to the table depicted in FIG. 7, the calculation of document characterization metrics, as at step 250, and document scores, as at step 260, will be briefly explained. It should be clear to practitioners in the fields of Decision Analysis and Decision Support Systems, that a method for selecting the best from among a set of candidate choices, may incorporate a plurality of metric scaling methods (including weighting factors) and threshold methods (identifying specific classes or conditions) well known in the art, e.g., sigmoid scaling, and that the present invention may be implemented using various combinations thereof. Likewise, the choice of document characterization metrics and document scores is not limited to those depicted in FIG. 7.

The DNE service (120) includes gathering candidate documents, analyzing candidate documents, and calculating metadata, i.e., document characterization metrics, user-centric document characterization metrics, and document scores, among which are the example metrics presented herein. These metadata are written to a table, such as (700), which is stored in the DNE data store (122). Following a title row, each row in the table (700) contains information specific to a given document that the DNE service (120) may select to show to the user based on his/her interaction with the DNE (102). The columns store an identifier (710) for efficient processing of each record, a hyperlink or other network address (720) to a document, a first document characterization metric wordCount (730), a second document characterization metric videoPresence (740), a third document characterization metric flashPresence (750), a fourth document characterization metric blogPresence (760), a first document score comfortScore (770), and a second document sore videoScore (780). For simplicity, the contents of specific cells in the table will be referenced herein according to their column name, e.g., wordCount, and document ID.

In this example, a scan of an HTML document (ID=1) from http://www.sample.com has identified 56 words visible to the user, hyperlinks to two MPEG-4 videos, Javascript interface code to launch a Flash animation, and a hyperlink to a known blog site. Thus, wordCount[1]=56, videoPresence[1]=TRUE, flashPresence[1]=TRUE, and blogPresence[1]=TRUE. Also calculated, but not shown in FIG. 7, are videoContentFactor[1]=0.4, videoDurationSeconds[1]=200, and pageVisits[1]=1. Accordingly, comfortScore[1]=0.48, videoScore[1]=80, and complexityScore[1]=0.37, the first two of which are displayed in FIG. 7. Using the same document characterization metric calculation rules and document scoring rules, the remaining rows of FIG. 7 may be calculated.

In the present embodiment of the invention, when a user selects the “Take Me Back” button (410) as illustrated in FIG. 4, or “Take Me Back” button in one of the possible variants of the DNE, as illustrated in FIG. 5, the DNE service (120) selects the document with the highest comfortScore as the one best to display to the user. In this example table (700) document ID=3 has a score of 0.87, and thus is selected. When a user selects a “Video” button, such as (451), the DNE service (12) selects the document with the highest videoScore as the one best to display to the user. In this example table (700) document ID=4 has a score of 105, and thus is selected.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of navigating within a set of documents, the method comprising the steps of:
identifying a candidate document,
calculating a document characterization metric,
calculating a document score that characterizes a user's anticipated level of comfort with a document, and
selecting and displaying a document with the best document score.

2. The method of claim 1, further comprising the step of characterizing the user's task context, including at least one of finding information, buying something, or being entertained.

3. The method of claim 2, wherein the user's task context is characterized in terms of types of desired content or services, including at least one of video, animated content, blogs, photo collections, shopping services, or documents in a specific format.

4. The method of claim 1, further comprising the step of identifying a set of keywords representing a user's recent document viewing and current task context.

5. The method of claim 1, wherein the document characterization metric is one of word count, video presence, video content factor, video duration, Flash animation presence, blog presence, information depth, semantic distance, number of page visits, or status as a favorite.

6. The method of claim 5, wherein a document's information depth is calculated in terms of the maximum node separation, degree of node interconnectedness, or other network structure metric, of a subset of WordNet nodes containing words occurring in the document.

7. The method of claim 1, wherein the document score is one of anticipated level of user comfort, complexity for the user to comprehend, predominance of video content, or degree of match with the desired information depth.

8. The method of claim 7, wherein the calculation of a document's complexity scores includes a comparison of the words used in the document, to a set of words constituting the vocabulary typical for an educational grade level.

9. The method of claim 7, wherein the calculation of a document's comfort score includes an analysis of its text font sizes, text font styles, lines of text, or percent of the viewable display area covered with text.

10. The method of claim 1, wherein the identification of a candidate document includes querying at least one of a document view history service, an on-demand network-based document collection service, a document recommendation finder service, a network-based document collection crawler service, or a document navigation element transcript service.

11. The method of claim 10, wherein the document recommendation finder service operates on documents accessible to a user within a Social Networking site.

12. The method of claim 11, wherein the document recommendation finder service characterizes a recommended document in terms of the number of times it has been designated as a favorite by members of a user's Social Network.

13. A system of navigating within a set of electronic documents, the system comprising:
a content identification module that identifies a candidate document,
a document characterization module that calculates a document characterization metric,
a document score generation module that calculates a score characterizing a user's level of comfort with a document, and
a document presentation module that selects and displays a document with the best score.

14. The system of claim 13, further comprising a task context identification module which characterizes the user's task context, including at least one of finding information, buying something, or being entertained.

15. The system of claim 13, further comprising a user interface with multiple control elements, by means of which a user can specify one or more desired attributes of a document, thereby constructing a document scoring function.

16. The system of claim 15, further comprising a control element which, by means of clicking on this element or otherwise activating it, initiates the selection and display of a document with which the user is expected to have a high level of comfort.

17. The system of claim 15, further comprising a moveable control element that, when moved to a different region of a user interface, it exchanges information with services displaying content in that region of the user interface, and adapts its functionality to reflect the likely user task context for the content in this region.

18. The system of claim 15, further comprising a moveable control element that, when a user changes its position relative to another control element, the selection or weighting of a document characterization metric for a control element, is correspondingly adjusted in the document score calculation.

19. The system of claim 13, further comprising an information depth characterization module calculating a document's information depth in terms of the maximum node separation, degree of node interconnectedness, or other network structure metric, of a subset of WordNet nodes containing words occurring in a document.

20. The system of claim 13, further comprising a grade level comparison module that includes a comparison of the words used in the document, to a set of words constituting the vocabulary typical for an educational grade level.
